(19) United States
(12) Patent Application Publication
(10) Pub. No.: US 2008/0041480 A1
(43) Pub. Date: Feb. 21, 2008

(54) BUFFERING MEANS FOR WATER-COOLING SYSTEM

(76) Inventor: Yu-Huang PENG, Chung-Ho City (TW)

Correspondence Address: HDSL, 4331 STEVENS BATTLE LANE, FAIRFAX, VA, 22033, US

(21) Appl. No.: 11/779,925

(22) Filed: Jul. 19, 2007

(30) Foreign Application Priority Data
Aug. 18, 2006 (TW) 095214677

(51) Int. Cl. F16L 55/02

(52) U.S. Cl. 138/30

(57) ABSTRACT

A buffering means for a water-cooling system is capable of buffering the volume expansion and pressure generated by heating a cooling liquid. The buffering means includes a tube that is formed into a rectangular pillar. The surfaces on both ends of the tube are provided with an inlet and an outlet respectively. The tube is provided thereon with a plurality of side faces. Each of the side face is provided with a metallic sheet that is recessed toward the interior of the tube under normal temperature. When the cooling liquid absorbs heat via a heat-exchanging action, the volume of the cooling liquid expands due to the increase in temperature. Further, when the internal pressure of the water-cooling system is increased, the increased volume and pressure of the cooling liquid may push the originally recessed metallic sheet outwardly to increase the internal space of the tube, thereby adjusting the internal pressure of the water-cooling system timely so as to protect the structural integrity of the water-cooling system.

### BACKGROUND OF THE INVENTION

1. Field of the Invention

The present invention relates to a heat-dissipating device, and in particular to a pressure-buffering means that is capable of water-cooling and heat-dissipating electronic elements.

2. Description of Prior Art

With the increase of the electricity consumption of electronic elements and power semiconductors, the density of the required electricity power for an associated system increases a lot accordingly. As a result, the amount of heat generated by the electricity-controlled elements is increasing to a substantial extent. In order to cool the electronic elements and keep the working temperature thereof stable, a heat-dissipating solution has become an important issue in developing the modern technology.

The most common way of dissipating heat is to use a fan. Compulsive airflow generated by the fan can drive the air to flow, thereby transferring the heat generated by the electronic elements into hot air and carrying to the outside. In this way, the temperature surrounding the electronic element can be reduced to assure that the electronic element operates under normal working temperature. However, the heat-dissipating efficiency of the fan depends on the amount of airflow generated by the fan. Therefore, in order to increase the amount of airflow generated by the fan, the volume of the fan has to be increased accordingly. However, since the volume of a general casing of a computer or communication machine is limited and such limited space thereof has already installed many elements therein to enhance the performance, the total heat generated by all of the elements is inevitably large. Thus, due to the restriction of space, the ventilating effect may be affected seriously, which causes the reduction of the heat-dissipating efficiency of the fan substantially.

Since the effect of the fan cannot satisfy the requirements for heat dissipation, in prior art, a water-cooling heat-dissipating system is proposed in which a water block is provided on the electronic element directly, and a cooling liquid (such as water) flowing through the interior of the water block takes the heat away by means of a heat-exchanging action. Then, the cooling liquid flows into a water cooler that is responsible for performing a heat-dissipating action in the water-cooling heat-dissipating structure, thereby dissipating the heat to the outside. Further, via the action of a pump, the heat can be dissipated to the outside continuously to achieve the water-cooling heat-dissipating effect.

Although the heat-dissipating effect of a water-cooling system helps to improve the heat-dissipating effect of electronic elements, in the conventional water-cooling heat-dissipating system, all components are connected and communicated with each other via soft tubes, so that the cooling liquid can flow in each component easily. However, since the cooling liquid having absorbed the heat may expand its volume and change its pressure, the volume of the soft tube connecting to each component may not bear so that the connecting point of the soft tube breaks or the soft tube itself fractures. Although the later-developed conventional art uses hard connecting tubes as channels for circulation to overcome the fracture of connecting points, the hard connecting tube still has an upper limit for bearing the expansion of volume and pressure of the cooling liquid. Therefore, when the volume or pressure increases to approach the upper limit of the connecting tube, the water-cooling system may have a risk of breaking. Thus, there is still room for improving the water-cooling heat-dissipating system.

### SUMMARY OF THE INVENTION

In view of the above drawbacks, the present invention is to provide a buffering means for a water-cooling system that is capable of buffering the internal pressure of the water-cooling system. Circulatory tubes of the water-cooling system are provided with a metallic sheet that can be extended and contracted, thereby increasing the volume of the circulatory tube timely to buffer the internal pressure of the water-cooling system. Via this arrangement, the structural integrity of the water-cooling system can be maintained.

The present invention provides a buffering means for a water-cooling system. The buffering means is mainly constituted of a tube that is formed into a rectangular pillar. The surfaces on both ends of the tube are provided with an inlet and an outlet respectively. The tube is provided thereon with a plurality of side faces. Each of the side face is provided with a metallic sheet that is recessed toward the interior of the tube under normal temperature. When the cooling liquid absorbs heat via a heat-exchanging action, the volume of the cooling liquid expands due to the increase in temperature. Further, when the internal pressure of the water-cooling system is increased, the increased volume and pressure of the cooling liquid push the originally recessed metallic sheet outwardly to increase the internal space of the tube, thereby adjusting the internal pressure of the water-cooling system timely.

### BRIEF DESCRIPTION OF THE DRAWINGS

FIG. 1 is a perspective view showing the structure of the present invention;

FIG. 2 is a cross-sectional view of the present invention;

FIG. 3 is an assembled view of the present invention;

FIG. 4 is a cross-sectional view showing the operation of the present invention;

FIG. 5 is a perspective view showing the structure of another embodiment of the present invention; and

FIG. 6 is a cross-sectional view showing the structure of a further embodiment of the present invention.

### DETAILED DESCRIPTION OF THE INVENTION

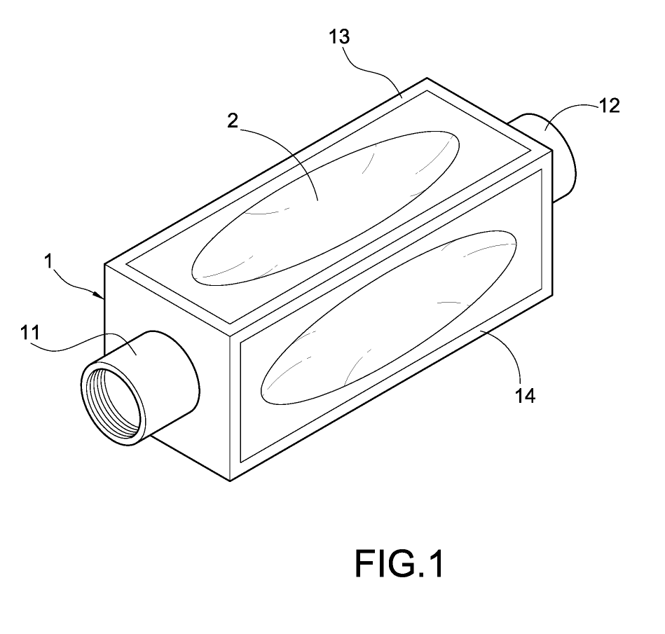

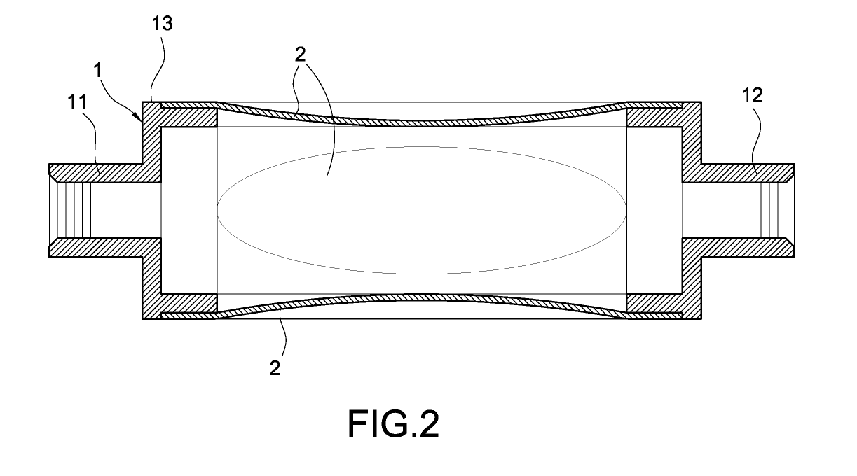

FIG. 1 and FIG. 2 are the perspective view and the cross-sectional view showing the structure of the present invention respectively. As shown in these figures, the buffering means of the present invention is mainly constituted of a tube 1. In the present embodiment, the tube 1 is made of metal and is formed into a pillar. The surfaces of front and rear ends of the tube 1 are provided with an inlet 11 and an outlet 12 respectively for connecting components (such as a water block or conduit, described in detail later) of a water-cooling system. In the present embodiment, the tube 1 is formed into a rectangular pillar and has four side faces. Each side face is provided with a metallic sheet 2. In the drawings, an upper side face 13 and a right side face 14 are shown. The upper side face 13 and the right side face 14 are provided with a metallic sheet 2 respectively that is integrally formed with the side face of the tube 1. The metallic sheet 2 is recessed toward the interior of the tube 1 under normal temperature and pressure (such a recess can be made by means of pressing the metallic sheet with a press-forming machine), as shown in the cross-sectional view of FIG. 2. In addition, the tube 1 can be a conduit or a water block.

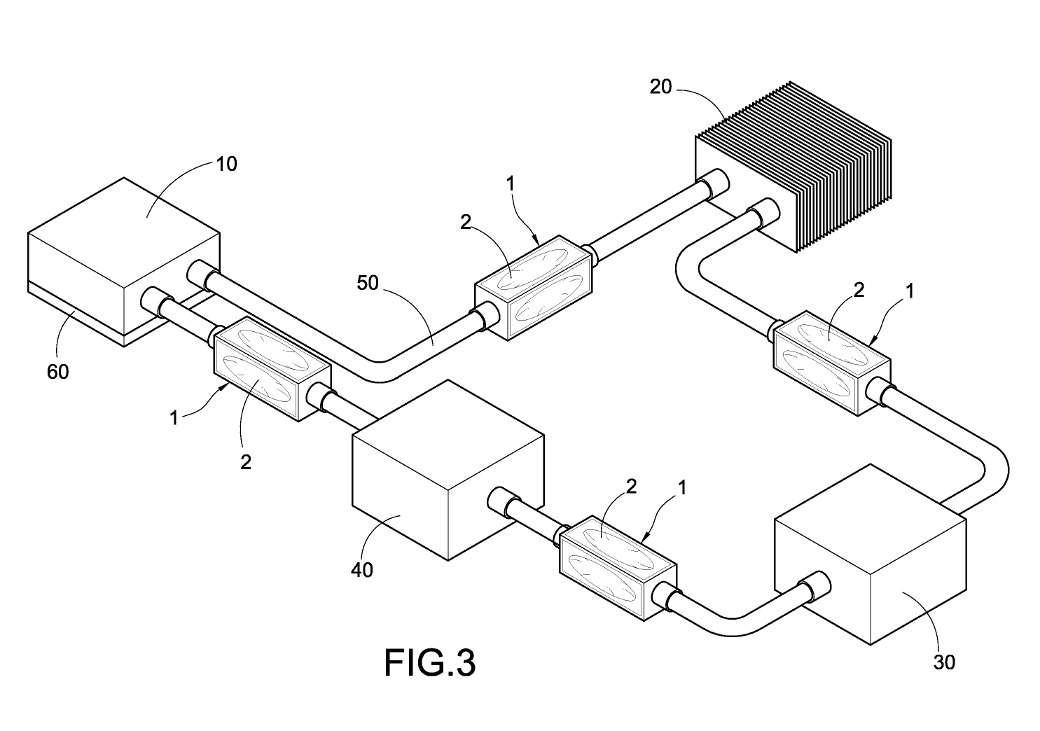

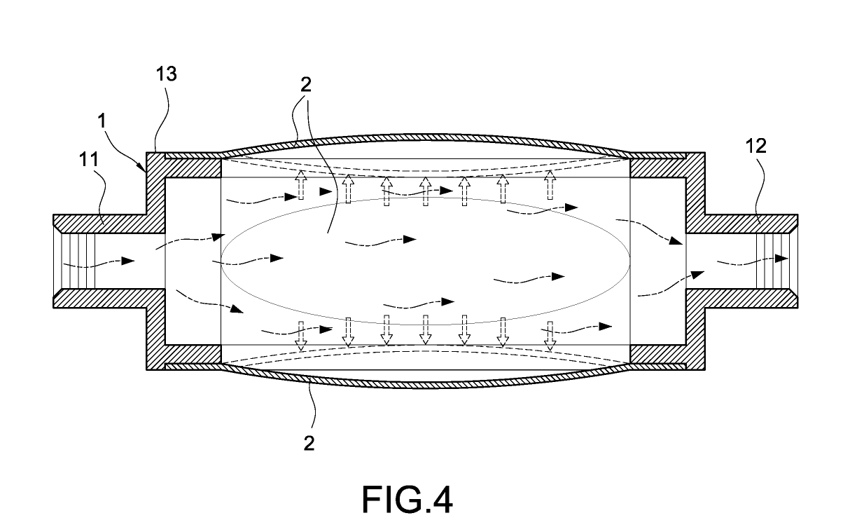

FIG. 3 is an assembled view of the present invention, and FIG. 4 is a cross-sectional view showing the operation of the present invention. As shown in these figures, the metallic tube 1 of the present invention is assembled on circulatory tubes of the water-cooling system. In the present embodiment, the water-cooling system includes a water block 10, a water cooler 20, a water tank 30 and a pump 40. A plurality of metallic tubes 1 each having metallic sheets 2 are communicated with each component via conduits 50, thereby providing the circulatory flow of the cooling liquid within the water-cooling system. When the water block 10 is adhered on an electronic element 60, the heat generated by the electronic element 60 can be transferred to the water block 10 by means of heat conduction. The water block 10 performs a heat-exchanging action with the cooling liquid flowing therein, thereby absorbing the heat generated by the electronic element 60 and taking the heat away from the water block 10. At this time, the cooling liquid absorbs the heat generated from the electronic element 60 to increase the temperature thereof As a result, at the time of increasing the temperature of the cooling liquid, the volume of the cooling liquid also increases, thereby increasing the internal pressure of the closed water-cooling system. When the cooling liquid that expands due to the heat flows through the metallic tube 1, the direction indicated by the arrows in FIG. 4 is the flowing direction of the cooling liquid. The increasing internal pressure pushes outwardly the metallic sheet 1 that is recessed originally toward the interior of the tube 1 (just like a swelling state as seen from a side view), thereby increasing the internal space of the metallic tube 1 and buffering the pressure generated in the water-cooling system. When the temperature of the cooling liquid within the water-cooling system lowers to a normal temperature and returns to the original volume, the metallic sheets 2 on the metallic tube 1 may contract due to the reduction of the internal pressure, so that the metallic sheets may return back to the original recessed state.

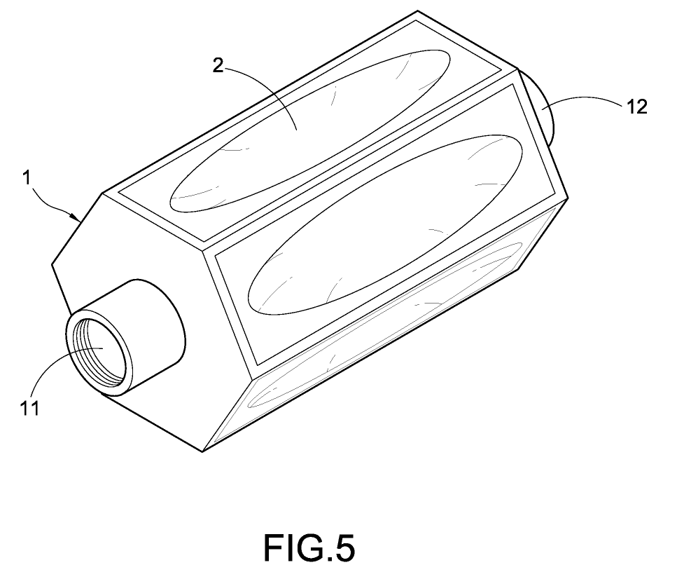

Further, in addition to the above-mentioned rectangular pillar, the tube 1 can be formed into a polygonal pillar as shown in FIG. 5. In the present embodiment, the metallic pillar 1 is a hexagonal pillar having a plurality of side faces thereon. At least one side face is provided with a metallic sheet 2. In the present embodiment, each side face is provided with a metallic sheet 2.

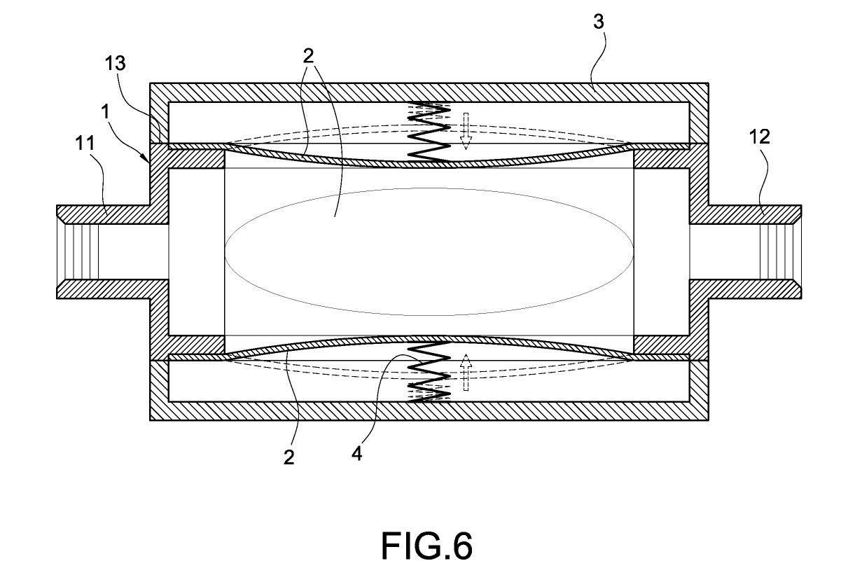

With reference to FIG. 6, it shows another embodiment of the present invention. The exterior of the tube 1 is provided with a cover 3 for surrounding the external surface of the tube 1. At the same time, an elastic element 4 is provided between the cover 3 and the metallic sheet 2. In the present embodiment, the elastic element 4 is a spring. One end of the elastic element is connected to the cover 3 (or to the metallic sheet 2). Alternatively, it can be connected to the cover 3 and the metallic sheet 2 simultaneously, so that the metallic sheet 2 can be pushed outwardly by the internal pressure to form a swelling state and press the elastic element 4. After the internal pressure is reduced, if the metallic sheet 2 cannot return to the original recessed state due to the reduction of the internal pressure, the pressed elastic element 4 can generate an elastic force to push the metallic sheet 2 back to the original recessed state, thereby forming a fool-proof mechanism.

Although the present invention has been described with reference to the foregoing preferred embodiments, it will be understood that the invention is not limited to the details thereof Various equivalent variations and modifications may still occur to those skilled in this art in view of the teachings of the present invention. Thus, all such variations and equivalent modifications are also embraced within the scope of the invention as defined in the appended claims.

What is claimed is:

1. A buffering means for a water-cooling system, capable of buffering an internal pressure of the water-cooling system and comprising:
a tube for connecting each component of the water-cooling system; and
a metallic sheet provided on an external surface of the tube, the metallic sheet being recessed toward an interior of the tube under normal temperature and pressure.

2. The buffering means for a water-cooling system according to claim 1, wherein the metallic sheet is integrally formed with the tube.

3. The buffering means for a water-cooling system according to claim 1, wherein the tube is a pillar.

4. The buffering means for a water-cooling system according to claim 1, wherein the tube is a rectangular pillar.

5. The buffering means for a water-cooling system according to claim 4, wherein the rectangular tube has a plurality of side faces, and at least one of the metallic sheets is provided on at least one side face of the rectangular tube.

6. The buffering means for a water-cooling system according to claim 1, wherein the tube is a polygonal pillar.

7. The buffering means for a water-cooling system according to claim 6, wherein the polygonal tube has a plurality of side faces, and at least one of the side faces is provided with a metallic sheet.

8. The buffering means for a water-cooling system according to claim 1, wherein the tube has an inlet and an outlet.

9. The buffering means for a water-cooling system according to claim 1, wherein the tube is constituted of a metallic material.

10. The buffering means for a water-cooling system according to claim 1, wherein the tube is a water block or a conduit.

11. The buffering means for a water-cooling system according to claim 1, wherein the tube is provided with a cover for surrounding an external surface of the tube, and an elastic element is provided between the cover and the metallic sheet.

12. The buffering means for a water-cooling system according to claim 11, wherein the elastic element is a spring.

13. The buffering means for a water-cooling system according to claim 11, wherein one end of the elastic element is connected to the cover or a surface of the metallic sheet.

14. The buffering means for a water-cooling system according to claim 11, wherein both ends of the elastic element are connected to the cover and a surface of the metallic sheet.
